(19) United States
(12) Patent Application Publication
(10) Pub. No.: US 2002/0185917 A1
(43) Pub. Date: Dec. 12, 2002

(54) Power control accessible via the internet

(76) Inventor: William S. Goss, Austin, TX (US)

Correspondence Address: Guy L. McClung, III PMB 347, 16690 Champion Forest Drive, Spring, TX, 77379-7023, US

(21) Appl. No.: 09/877,296

(22) Filed: Jun. 8, 2001

(51) Int. Cl. H02J 4/00

(52) U.S. Cl. 307/112

(57) ABSTRACT

A control apparatus which, in one particular aspect is accessible via the Internet, the control apparatus including in at least certain embodiments apparatus for controlling electrical power for an electrically powered device, the electrically powered device having a device power cord with a plug for connection into a power outlet, the control apparatus including an enclosure with an interior space, an opening through which a portion of the device power cord extends so that the plug of the power cord is positioned in the interior space of the enclosure, a power outlet within the enclosure to which the plug of the powered device is connected for providing electrical power to the powered device, an apparatus power cord extending from the power outlet from the enclosure, the apparatus power cord for connection to a power source for providing electrical power to the power outlet, a lockable switch interposed between the power outlet and the apparatus plug for selectively controlling the flow of power from the power source through the apparatus power cord to the power outlet and thus to the powered device, a communication system interconnected with the control apparatus and accessible via a remote device, the communication system providing communication between the control apparatus and the remote device to activate the control apparatus and to remotely operate the lockable switch, and a remote device for communicating with the communication system for remotely accessing, activating and operating the control apparatus.

### BACKGROUND OF THE INVENTION

1. Field of the Invention

This invention is directed to controls for electrically powered devices, apparatuses, and machines; to such controls accessible via the Internet; and, in certain particular aspects, to an enclosure for a power cord end with a keyed (and/or combination requiring) switch for selectively and securely completing a power circuit.

2. Description of Related Art

Many parents are concerned that children play video games too much, watch too much television, or watch undesirable shows. Sensitive information is stored in electronic devices and computers and there is often a need to prevent access to this information by other than authorized personnel. Controlling and restricting access to any electrically powered device may involve issues of security, propriety and control. Various apparatuses and devices are in the prior art to control access to televisions (e.g., V-Chip), computers (e.g., various types of security programs) and other devices, which inlcude “high-tech” devices and other simpler control and locking devices. Some of these are related solely and particularly to a specific computer or device, and do not provide a simple, low-cost, easy-to-use solution for universally controlling and restricting access to any and all devices powered by electricity.

U.S. Pat. Nos. 5,911,586; 6,011,328; 6,056,563; 6,159,025 and the prior art cited in these patents presents the general state of the art of devices and appratuses for controlling electrically powered items.

### SUMMARY OF THE PRESENT INVENTION

The present invention, in certain embodiments, discloses an apparatus for selectively controlling power for an electrically powered device which has a power cord. In certain aspects the power cord has a typical plug for plugging into a power source such as a typical female wall power outlet (including, but not limited to, machines, motors, appliances, televisions, computers, radios, video recorders, video players, DVD players, tape recorders, copiers). In other aspects a power cord has in its circuit a switch apparatus according to the present invention. In certain aspects such an apparatus for use with a device having a power cord with a plug includes a lockable switch interposed between the male plug of the powered device and the power source. The lockable 1 switch has a female receptacle which receives the male plug of the powered device and its own male plug for plugging into the power source. The power circuit between the powered device and the power source is completed only when the lockable switch is activated (e.g. by insertion of a key into a keyed lockable switch; by correct positioning of coded discs or tumblers in a mechanical multi-unit lockable switch; or by inputting a correct code or combination into an electronic lockable switch).

Optionally, the male plug of the powered device and the female receptacle of the lockable switch may be enclosed in a permanent enclosure or in an openable enclosure (e.g., but not limited to an enclosure with a removable portion or access door and/or with a hinged portion or access door). In one aspect, an end for receiving a key of a keyed lockable switch is flush with a portion of or projects out from such an enclosure. Optionally, a surge protector may be included in the circuit that includes the lockable switch, either in or outside of the enclosure. The lockable switch and its associated female outlet may be in a single integral body or the female outlet may be at a distal end of a power cord extending from the lockable switch.

In another embodiment in which the male plug of the powered device is enclosed in an openable, lockable enclosure, a timer device is also included (or is used instead of a lockable switch) within the enclosure or exteriorly thereof. The enclosure (if the timer is inside it) is unlocked and opened; the timer is set; then the enclosure is closed and locked. In one aspect the timer device turns a powered device, e.g. but not limited to a television or a light, on and/or off at a preset time or times.

In another embodiment a system as described above includes a signal generator inside or outside of an enclosure which generates a desired signal to a powered device, e.g., but not limited to, to a television. In one particular aspect such an embodiment includes a timer so that a message signal is sent to the powered device at a pre-set time or times. In another particular aspect the powered device includes a screen that displays the message associated with the message signal and/or speaker apparatus for providing a sound message.

In other aspects an apparatus as described above may, optionally, include an alarm or alerting apparatus, e.g. an audible signal or a light (blinking or turned on as an indicator).

In another aspect such an apparatus is connected to a reception/control apparatus (e.g. via wireless radio, cell phone, satellite, or phone line) which is remotely accessible to activate the signal generator, the lockable switch, and/or timer; and/or to determine system status (e.g. is the switch presently activated or not ? is an enclosure open or closed ? is a timer operational ? did a timer operate ?). In one particular aspect the reception apparatus includes apparatus for connection to a global communication system (e.g. the Internet) so that a person with a personal computer or similar device at a location remote from the apparatus can activate the lockable switch, check system status, activate a timer, etc.

It is, therefore, an object of at least certain preferred embodiments of the present invention to provide:

Power control apparatus which includes a selectively lockable switch for controlling power to a powered device;

Such an apparatus with an enclosure, which in one aspect is selectively openable, for enclosing a male plug of the powered device;

Such an apparatus which is accessible activatable, and controllable from a remote location; in one particular aspect, via the Internet;

Such an apparatus in which the selectively lockable switch includes a mechanical locking mechanism and/or an electronic locking device;

Such an apparatus with a timer device and/or a signal generator and/or a surge protector; and

New, useful, unique, efficient, nonobvious and effective methods for using any such apparatus.

Certain embodiments of this invention are not limited to any particular individual feature disclosed here, but include combinations of them distinguished from the prior art in their structures and functions. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses the previously-mentioned problems and long-felt needs and provides a solution to those problems and a satisfactory meeting of those needs in its various possible embodiments and equivalents thereof. To one skilled in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

### DESCRIPTION OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIGS. 1-4 are schematic views of systems according to the present invention.

FIG. 5 is a side view in cross-section of a connector assembly according to the present invention.

FIG. 6A is a schematic view of a system according to the present invention. FIG. 6B is an end view of the box of the system of FIG. 6A.

### DESCRIPTION OF EMBODIMENTS PREFERRED AT THE TIME OF FILING FOR THIS PATENT

FIG. 1 shows a system 10 according to the present invention which has a box 20 which may be opened to receive a male end 31 of a power cord 32 of an electrically powered device 18. A power cord 34 is connected to apparatus within the box 20 and has a male plug end 41 for selective insertion into a power source 12. Suitable openings or cutouts (not shown in FIG. 1) are provided (e.g. like the slots in the box of FIG. 6B) for the cords 32 and 34.

A keyed power switch 50 has an end 51 projecting out from the box 20 and a portion 52 within the box 20. Both power cords 32 and 34 are connected to the switch 50. An optional surge protector 36 may be used with the power cord 34 (and such a surge protector may also be used for the powered device 30).

A female power inlet or receptacle 38 is connected to the power switch 50 with a power cord 39. Alternatively the inlet 38 may be formed with or directly connected to the switch 50.

By inserting a key 14 into a key inlet (not shown) in the end 51 of the switch 50 and turning the key, a circuit is completed from the power source 12 to the powered device 18.

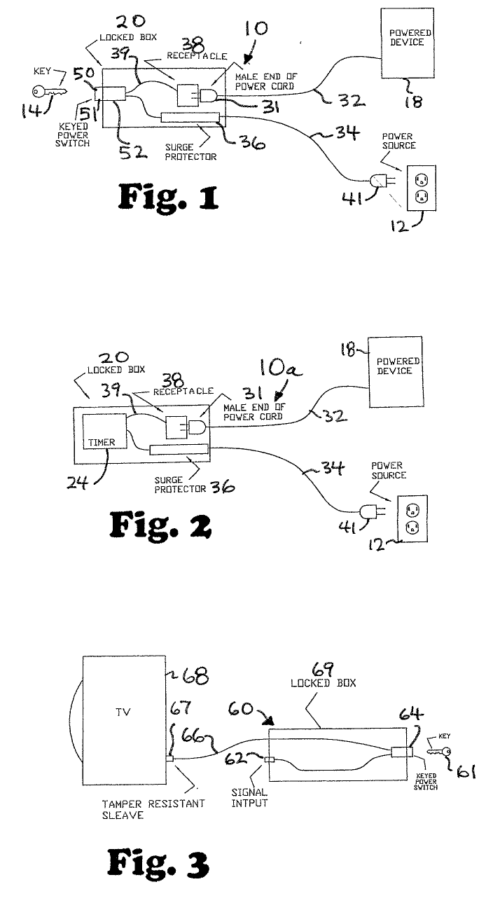

FIG. 2 illustrates a system 10a, an alternative for the system 10 in which there is no switch 50. A timer 24 within the box 20 is accessible when the box is opened. The timer 24 is pre-set as desired to selectively complete the power-source/powered-device circuit to permit the powered device to operate, run, or be “on.” Such a timer 24 may also be included in the system 10 as shown in FIG. 1.

FIG. 3 shows a system 60 according to the present invention which has a powered device 68 (e.g., but not limited to, a radio, phone, or television) that receives a signal from a signal source (not shown). The signal is input to a signal input device or connector 62 which itself is connected to a power switch 64 (like the switch 50, FIG. 1). A line or cable 66 conveys the signal from the switch 64 to a signal receiving apparatus, appliance or device 67.

When properly set (e.g. by inserting and turning a key 61 in the power switch 64) an input signal is provided to the apparatus 68. When the key is not present, no signal flows to the apparatus 68. A box 69 is like the box 20, FIG. 1.

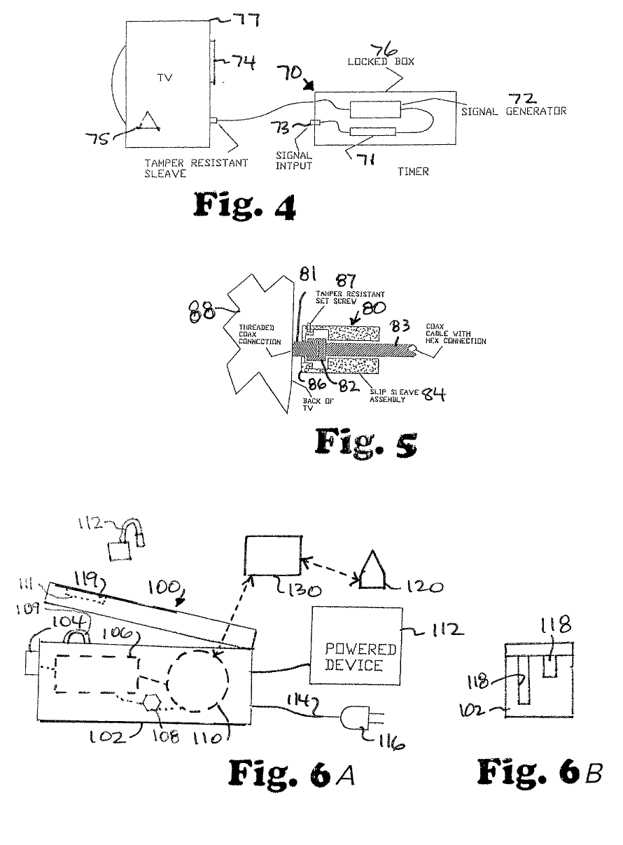

FIG. 4 shows a system 70, like the system 60, FIG. 3, but with a timer device 71 which can be pre-set to permit an input signal be to transmitted at a desired time or time(s) to an appliance or device 77 (like the appliance, etc. 67, FIG. 3). A signal generator 72 transmits the signal from a signal input device 73 to the appliance or device 77. The signal generator 72 may also send a desired pre-set message to the appliance 77. In one aspect the appliance 77 has a display screen 74 on which the message is displayed and/or audio apparatus 75 for producing an audible message. A lockable, openable box 76 (like the box 20, FIG. 1) encloses the various components. A keyed power switch may be used with the system 70 and a timer 71 may be used in the system 60, FIG. 4.

FIG. 5 shows an assembly 80 for enclosing a mating end of a cable and a connector. A television 88 (e.g.) has a threaded coax connector 81 to which is releasably attached an end 82 of a coax cable 83. A sleeve 84 encompasses part of the cable 83 and the end 82. A member 86 encompasses the connector 81. One or more set screens 87 secure the sleeve 84 to the member 86 so that access to the connector/cable connection is prevented.

FIG. 6A shows a system 100 according to the present invention which has a lockable box 102 with a keyed power switch 104 interconnected with apparatus 106 which may include any and all apparatus(es) and device(s) disclosed herein in the systems of FIGS. 1-5 above. A reception/control system 110 for providing communication between the control apparatus and one or more remote devices is connected to and in communication with the switch 104 and apparatus 106. The system 110 may be accessed by a remote device 120 via a remote or on-site system 130. A powered device 112 is like the powered devices of the systems 10, 10a, 60 and 70 described above and a power cord 114 and plug 116 are like those described above.

In one aspect the system 110 includes a modem; the system 130 is a communication system, e.g. a cell phone system, a satellite, communication system, or the Internet; and the device 120 is a cell phone, radio telephone, or a suitable computer or computers (as may be the system 110). Using the device 120 in a location remote from the lockbox 102, a person can communicate with the system 100 to determine system status; to activate or deactivate the switch 104; and/or to set, activate, or disable a timer or signal generator.

Slots 118 provide for passages of cables or cords through an end of the lockbox 102. A movable lid 119 may be hingedly connected to the lockbox 102. Such slot(s) and/or lid may be used with any lockbox in any system disclosed herein.

An alarm 108 interconnected with apparatus 106 provides an alarm to indicate that the switch 104 has been activated. optionally, the alarm 108 can send a signal via the system 110 that the switch 104 has been activated and/or the alarm 108 is accessible via the system 110 to see if an alarm has been given.

The enclosure 102 (and any enclosure according to the present invention) may have a conventional hasp 109 which extends through an opening 111 which itself is selectively secured with a conventional padlock 112 or, as desired any known mechanism, device and/or apparatus may be used to selectively lock a movable enclosure portion to a main enclosure body to prevent unwanted access to the enclosure's interior.

A communication system and/or remote device (e.g. as in the system of FIG. 6A) may be used with any known power control system, including, but not limited to, those disclosed in U.S. Pat. Nos. 5,911,586; 6,011,328; 6,056,563; 6,159,025—and in the references cited in all of these patents—all such patents and references fully incorporated herein for all purposes.

The present invention, therefore, in certain but not necessarily all embodiments, discloses a control apparatus for controlling electrical power for an electrically powered device, the electrically powered device having a device power cord with a plug for connection into a power outlet, the control apparatus including an enclosure with an interior space, an opening through which a portion of the device power cord extends so that the plug of the power cord is positioned in the interior space of the enclosure, a power outlet within the enclosure to which the plug of the powered device is connected for providing electrical power to the powered device, an apparatus power cord extending from the power outlet from the enclosure, the apparatus power cord for connection to a power source for providing electrical power to the power outlet, a lockable switch interposed between the power outlet and the apparatus plug for selectively controlling the flow of power from the power source through the apparatus power cord to the power outlet and thus to the powered device, a communication system interconnected with the control apparatus and accessible via a remote device, the communication system providing communication between the control apparatus and the remote device to activate the control apparatus and to remotely operate the lockable switch, and a remote device for communicating with the communication system for remotely accessing, activating and operating the control apparatus. Such a control appratus may be one wherein the remote device includes a computer, the communication system includes a computer, and the communication is accessible by the remote device via the Internet.

The present invention, therefore, in certain but not necessarily all embodiments, discloses a control appratus for controlling electrical power for an electrically powered device, the electrically powered device having a device power cord with a plug for connection into a power outlet, the control apparatus including an enclosure with an interior space, an opening through which a portion of the device power cord extends so that the plug of the power cord is positioned in the interior space of the enclosure, a power outlet within the enclosure to which the plug of the powered device is connected for providing electrical power to the powered device, an apparatus power cord extending from the power outlet from the enclosure, the apparatus power cord having an apparatus plug for connection to a power source for providing electrical power to the power outlet, and a lockable switch interposed between the power outlet and the apparatus plug for selectively controlling the flow of power from the power source through the apparatus power cord to the power outlet and thus to the powered device. Such a control apparatus may have one, some(in any possbile combination) or all of the following:wherein the plug of the device power cord is a device male plug, the power outlet has a female inlet for receiving and into which is inserted the male plug, the plug of the apparatus power cord is an apparatus male plug, and the power source having a female inlet for receiving and into which is inserted the apparatus male plug; wherein the lockable switch is a mechanical keyed switch operable by a key inserted therein; a surge protector interconnected therewith to protect the control apparatus against power surges; wherein the lockable switch is an electronically lockable switch; wherein the lockable switch is a combination-requiring lockable switch; timer apparatus interconnected with a power cord of the control apparatus, the timer apparatus selectively operable to permit power to flow through the control apparatus to the electronically powered device at at least one pre-set time; wherein the at least one preset time is a plurality of pre-set times; signal generator apparatus for generating at least one signal and for transmitting the at least one signal to the electrically powered device, the signal generator apparatus operatively interconnected with the control apparatus and the electrically powered device; wherein the at least one signal is a plurality of signals; timer apparatus interconnected with a power cord of the control apparatus, the timer apparatus selectively operable to permit power to flow through the control apparatus to the electronically powered device at at least one pre-set time, and the timer apparatus also for controlling the signal apparatus so that the signal apparatus is selectively activated to transmit a signal at at least one pre-set time; the electrically powered device including signal emitting apparatus for emitting a signal indicative of a signal transmitted by the signal generator apparatus wherein the signal emitting apparatus is from the group consisting of a screen, light apparatus, and an audio system with speaker apparatus for emitting a sound signal; a communication system interconnected with the control apparatus and accessible via a remote device, the communication system providing communication between the control apparatus and the remote device to activate the control apparatus and to remotely operate the lockable switch, and a remote device for communicating with the communication system for remotely accessing, activating and operating the control apparatus; wherein the remote device includes a computer, the communication system includes a computer, and the communication is accessible by the remote device via the Internet;the enclosure having a movable portion for selectively providing access to the interior space of the enclosure; and/or alarm apparatus for providing an alert that the lockable switch has been activated.

The present invention, therefore, in certain but not necessarily all embodiments, discloses methods for controlling electrical power to an electrically powered device usng any of the control apparatuses disclosd herein.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. This specification and the claims that follow are in accordance with all of the requirements of 35 U.S.C. §112.

What is claimed is:

1. A control apparatus for controlling electrical power for an electrically powered device, the electrically powered device having a device power cord with a plug for connection into a power outlet, the control apparatus comprising
an enclosure with an interior space,
an opening through which a portion of the device power cord extends so that the plug of the power cord is positioned in the interior space of the enclosure,
a power outlet within the enclosure to which the plug of the powered device is connected for providing electrical power to the powered device,
an apparatus power cord extending from the power outlet from the enclosure, the apparatus power cord for connection to a power source for providing electrical power to the power outlet,
a lockable switch interposed between the power outlet and the apparatus plug for selectively controlling the flow of power from the power source through the apparatus power cord to the power outlet and thus to the powered device,
a communication system interconnected with the control apparatus and accessible via a remote device, the communication system providing communication between the control apparatus and the remote device to activate the control apparatus and to remotely operate the lockable switch, and
a remote device for communicating with the communication system for remotely accessing, activating and operating the control apparatus.

2. The control apparatus of claim 1 wherein the remote device includes a computer, the communication system includes a computer, and the communication is accessible by the remote device via the Internet.

3. A control apparatus for controlling electrical power for an electrically powered device, the electrically powered device having a device power cord with a plug for connection into a power outlet, the control apparatus comprising
an enclosure with an interior space,
an opening through which a portion of the device power cord extends so that the plug of the power cord is positioned in the interior space of the enclosure,
a power outlet within the enclosure to which the plug of the powered device is connected for providing electrical power to the powered device,
an apparatus power cord extending from the power outlet from the enclosure, the apparatus power cord having an apparatus plug for connection to a power source for providing electrical power to the power outlet, and
a lockable switch interposed between the power outlet and the apparatus plug for selectively controlling the flow of power from the power source through the apparatus power cord to the power outlet and thus to the powered device.

4. The control apparatus of claim 1 wherein the plug of the device power cord is a device male plug,
the power outlet has a female inlet for receiving and into which is inserted the male plug,
the plug of the apparatus power cord is an apparatus male plug, and the power source having a female inlet for receiving and into which is inserted the apparatus male plug.

5. The control apparatus of claim 3 wherein the lockable switch is a mechanical keyed switch operable by a key inserted therein.

6. The control apparatus of claim 3 further comprising
a surge protector interconnected therewith to protect the control apparatus against power surges.

7. The control apparatus of claim 3 wherein the lockable switch is an electronically lockable switch.

8. The control apparatus of claim 3 wherein the lockable switch is a combination-requiring lockable switch.

9. The control apparatus of claim 3 further comprising
timer apparatus interconnected with a power cord of the control apparatus, the timer apparatus selectively operable to permit power to flow through the control apparatus to the electronically powered device at at least one pre-set time.

10. The control apparatus of claim 9 wherein the at least one pre-set time is a plurality of pre-set times.

11. The control apparatus of claim 3 further comprising
signal generator apparatus for generating at least one signal and for transmitting the at least one signal to the electrically powered device, the signal generator apparatus operatively interconnected with the control apparatus and the electrically powered device.

12. The control apparatus of claim 11 wherein the at least one signal is a plurality of signals.

13. The control apparatus of claim 11 further comprising
timer apparatus interconnected with a power cord of the control apparatus, the timer apparatus selectively operable to permit power to flow through the control apparatus to the electronically powered device at at least one pre-set time, and
the timer apparatus also for controlling the signal apparatus so that the signal apparatus is selectively activated to transmit a signal at at least one pre-set time.

14. The control apparatus of claim 11 further comprising
the electrically powered device including signal emitting apparatus for emitting a signal indicative of a signal transmitted by the signal generator apparatus.

15. The control apparatus of claim 14 wherein the signal emitting apparatus is from the group consisting of a screen, light apparatus, and an audio system with speaker apparatus for emitting a sound signal.

16. The control apparatus of claim 3 further comprising
a communication system interconnected with the control apparatus and accessible via a remote device, the communication system providing communication between the control apparatus and the remote device to activate the control apparatus and to remotely operate the lockable switch, and
a remote device for communicating with the communication system for remotely accessing, activating and operating the control apparatus.

17. The control apparatus of claim 16 wherein the remote device includes a computer, the communication system includes a computer, and the communication is accessible by the remote device via the Internet.

18. The control apparatus of claim 3 further comprising
the enclosure further comprising
a movable portion for selectively providing access to the interior space of the enclosure.

19. The control apparatus of claim 3 further comprising
alarm apparatus for providing an alert that the lockable switch has been activated.

20. A method for controlling electrical power to an electrically powered device having a device power cord with a plug for connection to a power outlet, the method comprising
connecting the device power cord to a control apparatus, the control apparatus comprising an enclosure with an interior space, an opening through which a portion of the device power cord extends so that the plug of the power cord is positioned in the interior space of the enclosure, a power outlet within the enclosure to which the plug of the powered device is connected for providing electrical power to the powered device, an apparatus power cord extending from the power outlet from the enclosure, the apparatus power cord having an apparatus plug for connection to a power source for providing electrical power to the power outlet, and a lockable switch interposed between the power outlet and the apparatus plug for selectively controlling the flow of power from the power source through the apparatus power cord to the power outlet and thus to the powered device, and
selectively operating the lockable switch.

21. Any patentable invention disclosed herein.
